(19) United States
(12) Patent Application Publication
(10) Pub. No.: US 2007/0206828 A1
(43) Pub. Date: Sep. 6, 2007

(54) DISTRIBUTED ACOUSTIC CABINET

(75) Inventors: Ronaldus Maria Aarts, Eindhoven (NL); Joris Adelbert Maria Nieuwendijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,406

(22) PCT Filed: Mar. 24, 2005
(86) PCT No.: PCT/IB05/51019

§ 371 Date: Sep. 28, 2006

(30) Foreign Application Priority Data
Apr. 1, 2004 (EP) 04101343.4

(51) Int. Cl. H04R 1/28

(52) U.S. Cl. 381/351

(57) ABSTRACT

An enclosure (1) for an acoustic transducer (2) comprises a first chamber (11) for accommodating the acoustic transducer (2) and a spaced apart second chamber (12), which first and second chambers are acoustically coupled by a coupling section (15). The coupling section may have a smaller diameter than the first and the second chamber. An optional further coupling section (16) may acoustically couple the first chamber (11) to an optional third chamber (13). The volume of the enclosure is distributed over the various chambers, thus providing a relatively large enclosure, even when the first chamber (11) is small. Any non-fundamental resonances induced by the coupling sections (15, 16) lie outside the active region of the transducer (2).

The present invention relates to a distributed acoustic cabinet. More in particular, the present invention relates to an enclosure for accommodating an acoustic transducer, such as a loudspeaker.

It is well known to accommodate a transducer, such as a loudspeaker, in a typically box-shaped enclosure or “cabinet”. Using a loudspeaker or similar transducer without an enclosure or at least a panel separating the front from the back of the transducer will result in a very limited amount of sound being produced as an acoustic “short-circuit” exists between the front and the back. In particular low-frequency sound will suffer from this “short-circuit”.

An enclosure eliminates such an acoustic “short-circuit” but may introduce other undesirable effects if not designed correctly. The air in the enclosure will typically act as a spring, thus raising the resonance frequency of the acoustic system constituted by the transducer and the enclosure, in particular when the volume of the enclosure is too small. As this is clearly undesirable, the volume of the enclosure must have a certain minimum volume relative to the dimensions of the transducer.

In many devices containing an acoustic transducer, the amount of space is necessarily limited. The housing of television sets, for example, is typically designed to be as small as possible, given the dimensions of the screen. Providing a relatively large enclosure for each loudspeaker will require the housing to be undesirably large and voluminous, while providing relatively small enclosures will result in the detrimental effects discussed above.

European Patent Application EP-A 0 519 509 discloses a woofer module for use in a television set having a CRT—Cathode Ray Tube—screen. The woofer module comprises an elongate enclosure in which a loudspeaker is accommodated, and two sound passageways. A first passageway is located at the front of the transducer, the second passageway connects the interior of the enclosure with its exterior. The enclosure may be mounted in the bottom rear part of a television housing, the two passageways conveying the sound from the back to the front of the television set.

Although this known enclosure avoids a large volume being taken up at a side of the television set, it has several drawbacks. The actual enclosure is still large and while it may be accommodated in a television set having a CRT screen, it is too large for a television set having an LCD—Liquid Crystal Display—or plasma screen. In addition, the sound passageways cause undesirable “coloring” of the sound, altering its frequency characteristics.

It is an object of the present invention to overcome these and other problems of the Prior Art and to provide an enclosure for an acoustic transducer, which enclosure can be easily accommodated in a relatively small housing while having a relatively large volume. Accordingly, the present invention provides an enclosure for an acoustic transducer, the enclosure comprising a first chamber for accommodating the acoustic transducer and a second chamber, which first and second chambers are acoustically coupled by a coupling section, wherein the first chamber and the second chamber are spaced apart.

By providing at least two chambers which are spaced apart but acoustically coupled, a large total volume can be obtained, even when the individual chambers each have a relatively small volume. As a result, the various chambers constituting the enclosure may be accommodated in different parts of the housing of a device, thus creating a distributed transducer enclosure.

It is noted that German Patent Application DE-A 31 44 545 discloses a partitioned enclosure for a transducer. This Prior Art enclosure comprises two adjacent chambers which are separated by a partition wall. The two chambers are acoustically coupled by a relatively short tube which extends into both chambers. The tube constitutes a resonance element and contributes to the acoustic properties of the acoustic system formed by the transducer and the enclosure. More in particular, the air in the tube acts as an acoustic mass in a so-called fourth order resonant system consisting of the acoustic moving mass of the transducer, the acoustic compliance of the first volume, the acoustic mass of the air in the tube and the acoustic compliance of the second volume. As a result, the operating frequency range of this known acoustic system is affected by the air mass in the tube. In the present invention, the chambers are not adjacent but spaced apart and the at least one coupling member is preferably designed in such a way that the air it contains contributes to the total volume of the enclosure instead of forming a separate acoustic mass.

In a preferred embodiment, the coupling section has a smaller diameter, or in general cross section, than the first chamber and/or the second chamber. That is, the coupling section has smaller inner dimensions, seen in a direction perpendicular to its length, than the chambers it couples. Providing a relatively narrow coupling section reduces the local dimensions of the enclosure, making it easier to accommodate the enclosure in a housing or, in general, to fit the enclosure in the space available. It will be understood that the coupling section(s) may have a round, oval, rectangular, octagonal or other cross-section and that the term diameter is not meant to limit the invention to substantially round coupling sections.

The combination of the chambers and the at least one coupling member will have specific acoustic characteristics. In a particularly preferred embodiment, the enclosure is dimensioned so as to constitute a so-called second order acoustic system. That is, the enclosure is preferably dimensioned in such a way that the acoustic system constituted by the transducer and the enclosure behaves in its operating frequency range as a second order system. Such a system is comparable to a conventional “closed box” system that consists of the acoustic compliance of the enclosure (including the transducer) and the acoustic mass of the transducer. In this way, any undesirable side effects (detrimental resonances) are kept out of the operating frequency range.

Although the enclosure of the present invention may have an opening in one or more of the chambers, for example for equalizing the static pressure in the enclosure or for providing a “bass reflex” effect, it is preferred that the enclosure of the present invention is substantially closed. That is, the enclosure preferably constitutes a substantially closed-off volume. Of course an opening has to be provided for the transducer to be in contact with the outside air but this opening is considered to be closed off by the transducer.

In a preferred embodiment, the enclosure further comprises a third chamber which is acoustically coupled with the first chamber or the second chamber by a further coupling section. This embodiment offers the advantage of a still larger volume or, a similar volume using smaller chambers. It is thus possible to distribute the volume of the enclosure over three or more chambers. It will be understood that further chambers, such as a fourth and optionally a fifth, coupled by corresponding coupling sections, may also be provided.

It is preferred that the further coupling section has a smaller diameter than the first chamber, the second chamber and/or the third chamber.

As mentioned above, the enclosure of the present invention can be accommodated in the available space in a flexible manner as the chambers can be distributed over said space. For example, the first chamber, the second chamber and the third chamber may constitute a three-dimensional arrangement. Additionally, or alternatively, the second chamber may have a longitudinal direction which is substantially perpendicular to a longitudinal direction of the first chamber. In this embodiment, the chambers are substantially elongate and are arranged at right angles relative to each other. It will be understood that various other arrangements are also possible, for instance the chambers being in line with each other, or being arranged at an acute or obtuse angle. Furthermore, it is not necessary for all chambers to lie in substantially the same plane. Instead, arrangements are possible in which the chambers extend in three, possibly mutually orthogonal directions, thus forming a three-dimensional arrangement.

It is further preferred that the transducer is located at an outer surface of the first chamber, that is, relatively close to the exterior of said chamber. This ensures that the sound produced by the transducer is not affected (that is, “colored”) by any passageways.

Although the invention has been discussed in the above while referring to a single transducer, it is possible for the enclosure to comprise two or more transducers, for example three or four transducers. The at least one transducer preferably is a loudspeaker having a moveable cone, but other transducers may also be applied, for instance electrostatic transducers.

The present invention additionally provides an audio system, comprising an acoustic transducer accommodated in an enclosure as defined above, particularly the acoustic transducer being accommodated in the first chamber. Such an audio system may further comprise an amplifier for providing an excitation signal to the at least one transducer, and preferably a signal source such as a tuner, a CD player, a DVD player, an MP3 player, a microphone and/or a computer.

In the audio system of the present invention, the design of the distributed enclosure may cause resonances to occur at certain frequencies. In an advantageous embodiment, therefore, the transducer operates in a frequency range chosen so as to exclude any higher resonance frequencies of the acoustic system constituted by the transducer and the enclosure. In this embodiment, therefore, only the fundamental (that is, typically the lowest) resonance frequency lies within the operating frequency range of the acoustic system. However, alternative embodiments are possible in which the operating range of the acoustic system is lower than any of its resonance frequencies.

In a particularly advantageous embodiment, the transducer is arranged for operating at the resonance frequency of the acoustic system of which it is part. Transducers mounted in an enclosure and operating at the (fundamental) resonance frequency of the acoustic system thus formed are very efficient and produce a high sound level at relatively low input currents. A particularly suitable example of an acoustic transducer designed for operating at its resonance frequency is described in European Patent Application EP with filing No. 03103396.2 (herewith incorporated by reference). In such transducers high quality factor (Q) is particularly preferred.

The present invention further provides a television set, in particular a television set comprising a flat screen, such as an LCD screen or a plasma screen, and a monitor, each provided with an enclosure according to the present invention.

The present invention will further be explained below with reference to exemplary embodiments illustrated in the accompanying drawings, in which:

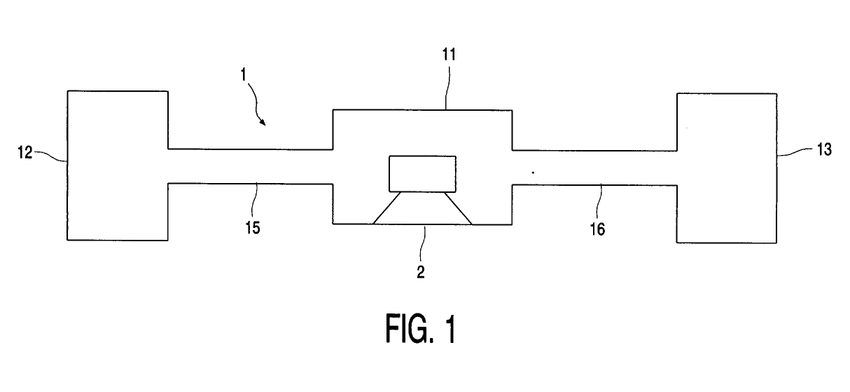

FIG. 1 schematically shows, in cross-sectional view, a first embodiment of an enclosure according to the present invention.

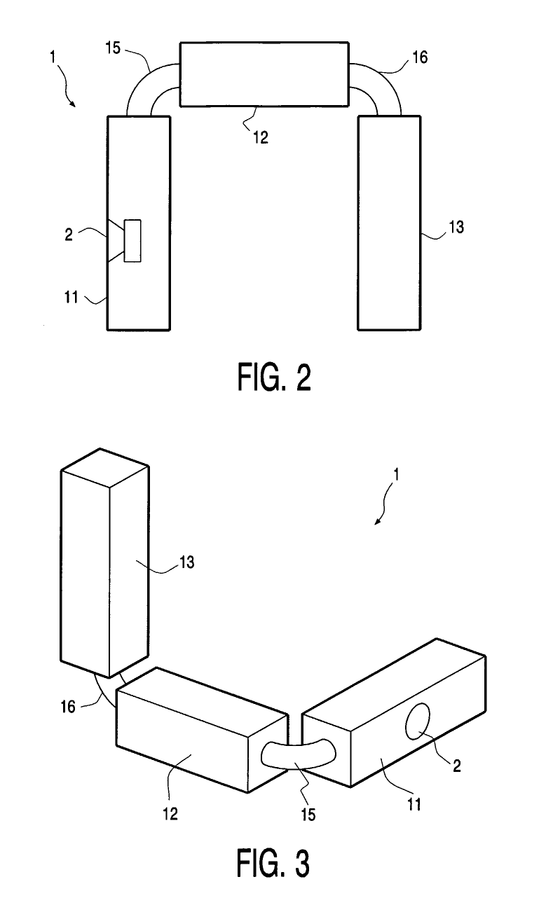

FIG. 2 schematically shows, in cross-sectional view, a second embodiment of an enclosure according to the present invention.

FIG. 3 schematically shows, in perspective, a third embodiment of an enclosure according to the present invention.

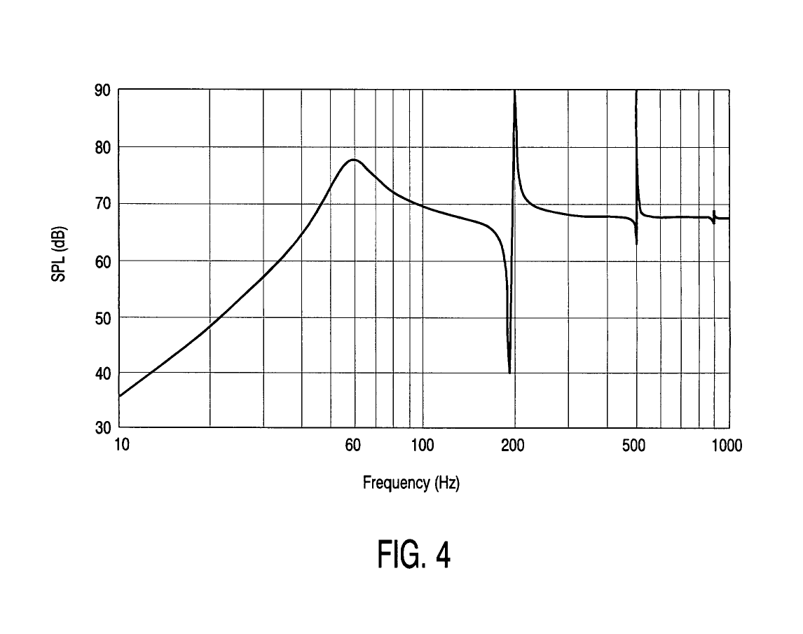

FIG. 4 schematically shows a frequency characteristic of an enclosure according to the present invention.

The enclosure 1 shown merely by way of non-limiting example in FIG. 1 comprises a first chamber 11, a second chamber 12, a third chamber 13, a first coupling section 15 and a second coupling section 16. An acoustic transducer 2, in the present example constituted by a loudspeaker, is accommodated in the first chamber 11 against a front wall in which one or more suitable openings are provided.

A first coupling section 15 connects the first chamber 11 and the second chamber 12, providing acoustic coupling. Similarly, a second coupling section 16 connects the first chamber 11 and the third chamber 13. In the example shown, the coupling sections 15 and 16 have a smaller diameter than the chambers 11, 12 and 13. However, embodiments can be envisaged in which the coupling sections have substantially the same diameter as the chambers. Also, in the example of FIG. 1 the chambers 11, 12 and 13 are arranged in line. This is, however, not necessary, as will be later explained with reference to FIG. 2.

In the exemplary embodiment of FIG. 1 the second chamber 12 and the third chamber 13 are located on either side of the first chamber 11 in which the transducer 2 is accommodated. In another embodiment (not shown) the third chamber 13 is coupled to the second chamber 12 and not to the first chamber 11. This embodiment still provides a distributed enclosure having a relatively large combined volume constituted by relatively small chamber volumes.

In the embodiment of FIG. 1, the first chamber 11 may have a volume of, for example 0.30 dm³, while the second and third chambers 12 and 13 may have a volume of 0.25 dm³ each. If the coupling sections 15 and 16 have a volume of 0.2 dm³ each, a total volume of 1.2 dm³ is obtained in this particular example. Thus the enclosure has a volume of 1.2 dm³ while the individual chambers have volumes not exceeding 0.30 dm³. It will be clear that it is much easier to accommodate the enclosure of the present invention in, for instance, the housing of a consumer device than Prior Art enclosures.

As mentioned above, the chambers 11 and 12, and any optional further chambers, are not necessarily in line. In the embodiment of FIG. 2, for example, the enclosure is substantially U-shaped. The second chamber 12 is arranged at right angles relative to the first chamber 11, while the third chamber 13 is again at right angles relative to the second chamber 12 and parallel to the first chamber 11. In this embodiment, the coupling sections 15 and 16 are constituted by the corners parts of the enclosure 1. A transducer 2 is accommodated in the first chamber 11, as in the embodiment of FIG. 1. Instead of the substantially two-dimensional arrangement of FIG. 2, a substantially three-dimensional arrangement is also possible, for example one in which three chambers 11, 12 and 13 extend in mutually orthogonal directions. Such an embodiment is illustrated in FIG. 3.

The embodiment of FIGS. 2 and 3 are particularly suitable for television sets or similar devices in which a single, large chamber cannot be accommodated. By using multiple distributed chambers in accordance with the present invention, a large enclosure is still obtained. It will be understood that the mutual arrangement of the chambers may be varied in accordance with the requirements of the particular application, for instance to suit a certain housing. The present invention can also be used for providing loudspeaker cabinets. Many consumers are reluctant to put a large, box-shaped loudspeaker cabinet in a room but would be more willing to accept a loudspeaker cabinet having a distributed design.

A frequency characteristic of an acoustic system of the present invention is schematically illustrated in FIG. 4. The sound pressure level (SPL) produced by a transducer that is accommodated in an enclosure (1 in FIGS. 1 and 2) of the present invention is shown as a function of the frequency f. The sound pressure level is measured in decibel (dB), the frequency in Hz on a logarithmic scale ranging from 10 Hz to 1000 Hz.

As can be seen, the arrangement of the transducer (2 in FIGS. 1 and 2) and the enclosure (1 in FIGS. 1 and 2) produce a peak sound pressure level (first or fundamental resonance) at approximately 60 Hz. Further resonances caused by the design of the enclosure, in particular the relatively narrow coupling sections (15 and 16 in FIG. 1) occur at approximately 200 Hz and 500 Hz.

According to a further aspect of the present invention, the acoustic system consisting of the at least one transducer and the enclosure has an effective operating range that does not overlap with any of the higher resonance frequencies. In the example of FIG. 4, the operating frequency range of the transducer extends below the higher resonance frequencies of the enclosure and may extend from, for example, 50 Hz to 150 Hz.

In a particularly advantageous embodiment, the at least one transducer is arranged for operating at the fundamental resonance frequency of the acoustic system, in the present example approximately 60 Hz. Transducers operating at the fundamental resonance frequency of the acoustic system are very efficient and produce a high sound level at relatively low input currents.

A particularly suitable example of an acoustic transducer designed for operating at a resonance frequency is described in European Patent Application with filing No. 03103396.2, the entire contents of which being herewith incorporated in this document.

A transducer accommodated in an enclosure of the present invention and designed to operate at the (fundamental or higher) resonance frequency of the acoustic system provides a very high sound level at low excitation currents while avoiding any single large cabinet chamber.

The present invention is based upon the insight that a relatively large acoustic enclosure can be obtained by providing two or more relatively small chambers which are acoustically coupled so as to form a distributed enclosure. The present invention benefits from the further insight that any resonance frequencies caused by the coupling of the chambers need not present a problem as the enclosure may be designed such that the higher resonance frequencies lie outside the active range of the acoustic system. The present invention further benefits from the additional insight that such an enclosure is particularly suitable for a transducer driven at a resonance frequency of the acoustic system.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. An enclosure (1) for an acoustic transducer (2), the enclosure comprising a first chamber (11) for accommodating the acoustic transducer (2) and a second chamber (12), which first and second chambers are acoustically coupled by a coupling section (15), wherein the first chamber (11) and the second chamber (12) are spaced apart.

2. The enclosure according to claim 1, wherein the coupling section (15) has a smaller cross section than the first chamber (11) and/or the second chamber (12).

3. The enclosure according to claim 1, which is dimensioned so as to constitute a second-order acoustic system.

4. The enclosure according to claim 1, which is substantially closed.

5. The enclosure according to claim 1, further comprising a third chamber (13) which is acoustically coupled with the first chamber (11) or the second chamber (12) by a further coupling section (16).

6. The enclosure according to claim 5, wherein the further coupling section (16) has a smaller diameter than the first chamber (11), the second chamber and/or the third chamber (13).

7. The enclosure according to claim 5, wherein the first chamber (11), the second chamber (12) and the third chamber (13) constitute a three-dimensional arrangement.

8. The enclosure according to claim 1, wherein the second chamber (12) has a longitudinal direction which is substantially perpendicular to a longitudinal direction of the first chamber (11).

9. The enclosure according to claim 1, wherein the transducer (2) is located at an outer surface of the first chamber (11).

10. The enclosure according to claim 1, comprising two or more transducers (2).

11. An audio system, comprising at least one acoustic transducer (2) accommodated in an enclosure (1) according to claim 1.

12. The audio system according to claim 11, further comprising an amplifier for providing an excitation signal to the at least one transducer (2), and preferably a signal source such as a tuner, a CD player, a DVD player, an MP3 player, a microphone and/or a computer.

13. The audio system according to claim 11, wherein the transducer (2) is arranged for operating in a frequency range chosen so as to exclude any higher resonance frequencies of the acoustic system constituted by the transducer (2) and the enclosure (1).

14. The audio system according to claim 11, wherein the transducer (2) is arranged for operating at the fundamental resonance frequency of the acoustic system constituted by the transducer (2) and the enclosure (1).

15. A television set, comprising at least one acoustic transducer (2) accommodated in an enclosure (1) according to claim 1.

16. A monitor, comprising an enclosure according to claim 1 and provided with an acoustic transducer.
